(19) United States
(12) Patent Application Publication
(10) Pub. No.: US 2024/0019268 A1
(43) Pub. Date: Jan. 18, 2024

(54) OUTLIER DETECTION METHOD OF DETECTING OUTLIERS IN MEASURED VALUES OF A MEASURAND

(71) Applicant: Endress+Hauser Group Services AG, Reinach (CH)

(72) Inventor: Dimitri Vaissiere, Rixheim (FR)

(21) Appl. No.: 18/351,885

(22) Filed: Jul. 13, 2023

(30) Foreign Application Priority Data
Jul. 13, 2022 (DE) 10 2022 117 436.0

(51) Int. Cl. G01D 1/00

(52) U.S. Cl. CPC G01D 1/00

(57) ABSTRACT

A method of detecting outliers in measured values of a measurand is disclosed, comprising the steps of: based on training data determining a combined distribution of differences between individual measured values and the filtered value of the measured value preceding the respective individual measured value to be expected in the application where the method is applied based on difference distribution of first differences of the filtered values of the measured values and a noise distribution of noise included in the measured values. Next, new measured values are identified as outliers when a probability of occurrence of a difference between the respective new measured value and the filtered value of the preceding measured value according to the combined distribution is lower than a predetermined level of confidence.

### CROSS-REFERENCE TO RELATED APPLICATION

The present application is related to and claims the priority benefit of German Patent Application No. 10 2022 117 436.0, filed on Jul. 13, 2022, the entire contents of which are incorporated herein by reference.

### TECHNICAL FIELD

The present disclosure concerns an outlier detection method, in particular a computer implemented outlier detection method, of detecting outliers in measured values of a measurand, and a method of determining and providing a measurement result of a measurand including the outlier detection method.

### BACKGROUND

Measured values of measurands of interest are determined and subsequently employed for various purposes in a large variety of different applications including industrial applications, as well as laboratory applications. In many applications, measured values of a measurand are, e.g., determined and provided by a measurement device measuring the measurand and subsequently employed to monitor, to regulate and/or to control the measurand, an operation of a plant or facility, e.g., a production facility, and/or at least one step of a process, e.g., a production process, performed at the application. For example, in a chemical production process, concentrations of reactants used in the production process and/or the concentration of analytes contained in pre-products, intermediate products and/or educts produced by the process can be monitored and a sequence of process steps of the production process can be scheduled, regulated and/or controlled based on measured values of the measurands. As an example, liquid analysis measurement devices measuring measurands, such as a pH-value, a concentration of free chlorine and/or a turbidity of a medium, are, e.g., employed in swimming pools, as well as in drinking water supply networks and water purification plants to monitor, to regulate and/or to control the quality of the water.

Depending on the specific application, an efficiency and/or a productivity of a production process, a product quality of products produced, the safety of operation of facilities, industrial plants and/or laboratories and/or the quality of drinking water may depend on the accuracy and the reliability of the measured values.

Even when highly accurate and reliable measurement devices are employed to determine the measured values, there always remains the problem, that the time series of measured values may include outliers, which significantly deviate from the true value of the measurand at the time. Outliers can occur due to a multitude of root causes associated with the application and/or the measurement device determining the measured values. Examples of root causes include disturbances occurring at a measurement site, where the measurand is determined, disturbances of a process performed at the application, where the measurand is determined, as a well as adverse measurement conditions a measurement device determining the measured values is exposed to.

When outliers remain unnoticed, there is a risk, that wrong decisions may be made, and/or unsuitable actions may be performed based on outliers included in the measured values. This risk is high in applications, where monitoring, regulating and/or controlling is performed based on measured values in a semi- or fully automated manner. As an example, when a valve on a supply pipe is closed due to an outlier indicating a high level of a medium inside a container, even though the true level is low, this may impair the quality of a product produced in the container and/or may even constitute a safety hazard.

In consequence, there is a need to detect outliers included measured values to prevent them from being employed any further. Outlier detection has been widely discussed in literature, but outlier detection methods capable of detecting outliers in real time are rare. Another problem is that these methods regularly operate based on parameters. To enable an accurate and reliable detection of outliers the determination of these parameters normally requires an expert analysis of the properties of the measured values, in particular of the time dependency of the measured values, and of the properties of noise included in the measured values followed by a manual adjustment of the parameters. The properties of the measured values and the noise are normally not known upfront. This makes an accurate determination of the required parameters a demanding, time and cost intensive process.

### SUMMARY

It is an object of the present disclosure to provide an outlier detection method capable of detecting outliers included in time series of measured values of a measurand, that enables outliers to be detected in real time without requiring an expert analysis or prior knowledge about the properties of the measured values and/or the noise included in them.

This object is achieved by an outlier detection method, in particular a computer implemented outlier detection method, of detecting outliers in measured values of a measurand comprising the steps of: continuously or repeatedly recording data including measured values of the measurand and their time of determination, determining filtered values of the measured values by filtering the measured values, and, based on training data included in the recorded data, determining a combined distribution of differences between individual measured values and the filtered value of the measured value preceding the respective individual measured value to be expected in the specific application where the outlier detection method is applied. The method includes determining a difference distribution of first differences of the filtered values, based on the filtered values of the measured values included in the training data, determining a noise distribution of noise included in the measured values, and, based on the noise distribution and the difference distribution determining the combined distribution.

d) identifying outliers by for at least one, several or each new measured value performing the steps of:
determining a difference between the respective new measured value and the filtered value of the measured value preceding the respective new measured value,
determining a probability of occurrence of this difference between the respective new measured value and the filtered value of the preceding measured value according to the combined distribution, and
identifying the respective new measured value as an outlier when the probability of occurrence of this difference is lower than a predetermined level of confidence, and

e) providing a detection result by performing at least one of: indicating each new measured value that has been identified as an outlier, issuing a warning when an outlier has been identified, and issuing a notification or an alarm when a predetermined number of consecutively determined new measured values has been identified as outliers.

The present disclosure provides the advantage, that the determination of the combined distribution is performed in an autonomous entirely data driven manner, that neither requires an expert analysis of the data nor any prior knowledge of the properties of the measured values and the properties of the noise. Thus, it is neither based on any assumptions, parameters or other inputs that may turn out not be valid for the specific application, where the method is employed. Based on the empirically determined combined distribution, the method enables for outliers to be detected in real time with a high accuracy and reliability, and in a manner truly accounting for the properties of the measured values and the noise in the specific application, where the outlier detection method is used. Another advantage is, that the difference distribution of the first differences and the noise distribution can be of any kind. Thus, neither the difference distribution nor the noise distribution must be compliant to predetermined requirements. This enables for the method to be universally employed regardless of the properties of these distributions. As an example, employment of the outlier detection method neither requires for the distributions to be Gaussian, nor to be symmetric, nor to be stationary, nor to be compliant to any other requirement.

According to a first embodiment, the noise distribution is determined:
as or based on a distribution of residues between the measured values included in the training data and the corresponding filtered values, or
based on a measurement uncertainty inherent to a measurement device determining and providing the measured values of the measurand, or
in form of a combined noise distribution determined based on the distribution of residues between the measured values included in the training data and the corresponding filtered values and a measurement uncertainty inherent to a measurement device determining and providing the measured values of the measurand, or
based on a distribution of residues between the measured values included in the training data and the corresponding filtered values such, that the noise distribution represents a probability of occurrence of noise as a function of a noise amplitude, wherein for each noise amplitude covered by the noise distribution the probability of occurrence is larger or equal to a probability of occurrence of noise of having the respective noise amplitude due to a measurement uncertainty inherent to a measurement device determining and providing the measured values of the measurand.

A second embodiment further comprises the steps of:
updating the combined distribution based on new training data included in the recorded data, and
subsequently performing the identification of outliers based on the updated combined distribution,
wherein updating of the combined distribution:
a) is performed at least once, repeatedly, or periodically,
b) is performed at least once, repeatedly, or periodically based on new training data including a given number larger or equal to one of measured values that have been determined after a training time interval during which the measured values included in the training data employed to determine the previously determined combined distribution have been determined,
c) is performed at least once, repeatedly, or periodically based on new training data including measured values, that have been determined during a time interval of a predetermined duration preceding the determination of the respective updated combined distribution,
d) is performed after an event occurred, that may have an impact on properties of the measured values and/or on properties of the noise,
e) is performed after an event given by a change of a constant time interval between consecutively determined measured values or by a change of at least one property of a distribution of time differences between consecutively determined measured values,
f) is performed after an event given by a time difference between anew measured value and the preceding measured value exceeding a predetermined time limit, and/or
g) includes a method step of determining a degree of similarity between the new training data and the training data employed in the previous determination of the combined distribution, followed by a method step of: updating the combined distribution when the degree of similarity is below a predetermined threshold and/or postponing the updating of the combined distribution in case the degree of similarity exceeds the predetermined threshold.

According to a third embodiment, the method step of filtering the measured values comprises:
based on the training data included in the data determining a parametrization for a filter having an adjustable filtering strength by:
setting the filtering strength to a predetermined initial filtering strength,
performing a process of by means of the filter filtering the measured values included in the training data and determining a fractal dimension of the filtered values provided by the filter, and
iteratively repeating this process by increasing the filtering strength of the filter to a higher filtering strength and by subsequently filtering the measured values and determining the fractal dimension of the filtered values determined by the filter having the higher filtering strength until a decay of the fractal dimensions determined at the end of each iteration of the process drops below a predetermined threshold, and
performing the filtering of the measured values with the filter operating based on a parametrization corresponding to the filtering strength employed in the last iteration.

According to an embodiment of the third embodiment, each iteration includes a method step of determining the decay of the fractal dimensions:
a) as or based on a ratio of the fractal dimension of the filtered values determined during the respective iteration and a fractal dimension of the unfiltered measured values included in training data, or
b) as or based on a ratio of the fractal dimension of the filtered values determined during the respective iteration and the fractal dimension of the filtered values determined during the previous iteration, or
c) based on three or more of the previously determined fractal dimensions and/or based on a property of a function fitted to several or all previously determined fractal dimensions.

According to an embodiment of the method according the second and the third embodiment, the parametrization of the filter is updated when the combined distribution is updated.

According to a fourth embodiment the identification of outliers is performed in real time, and/or the training data is unlabeled data and/or includes a predetermined number of measured values and/or measured values that have been measured during an initial and/or a predetermined training time interval or an arbitrarily selected time interval of a predetermined duration.

The present disclosure further includes a method of using the outlier detection method in a method of determining and providing a measurement result of a measurand comprising the steps of:
by means of a measurement device repeatedly or continuously determining and providing measured values of the measurand,
wherein the measurement device is either:
a physical device measuring the measurand at a measurement site, or
is given by a virtual device, a computer implemented device or a soft sensor repeatedly or continuously determining and providing the measured values of the measurand based on data provided to it,
based on the measured values and their time of determination performing the outlier detection method, and
determining and providing the measurement result of the measurand based on the measured values and the detection result determined by performing the outlier detection method.

According to certain embodiments of the method of using the outlier detection method:
a) providing the measurement result includes providing the detection result and providing the measured values, filtered values of the measured values, and/or processed measured values determined based on the measured values and/or the filtered values, or
b) determining the measurement result includes based on the detection result eliminating each new measured value that has been identified as an outlier and determining and providing the measurement result includes at least one of: eliminated,
b1) providing the remaining measured values remaining after the outliers have been
b2) providing filtered values of the remaining measured values,
b3) providing processed measured values determined based on the remaining measured values and/or based on filtered values of the remaining measured values, and
b4) performing at least one of: providing the detection result, indicating each new measured value that has been identified as an outlier, issuing a wanting when an outlier has been identified and/or issuing a notification or an alarm when a predetermined number of consecutively determined new measured values has been identified as outliers.

In certain embodiments the method of using the outlier detection method further comprises at least one of the steps of:

performing the method of determining and providing the measurement result of the measurand for two or more measurands,
monitoring, regulating and/or controlling the measurand or at least one of the measurands, monitoring, regulating and/or controlling an operation of a plant or facility and/or monitoring, regulating and/or controlling at least one step of a process performed at an application, where the measurement device(s) is/are employed, based on the measurement result(s), and
providing the measurement result(s) of the measurand(s) to a superordinate unit configured to monitor, to regulate and/or to control the respective measurand, an operation of a plant or facility, and/or at least one step of a process performed at the application, where the measurement device(s) determining the measured values of the measurand(s) is/are employed.

The present disclosure further includes a measurement device configured to perform the method of determining and providing a measurement result, comprising:
a measurement unit configured to determine and to provide the measured values of the measurand,
computing means, a memory associated to the computing means and a computer program installed on the computing means which, when the program is executed by the computing means, cause the computing means to carry out the method of determining and providing the measurement result based on the measured values provided to the computing means by the measurement unit.

The present disclosure further includes a measurement system configured to perform the method of determining and providing a measurement result for at least one measurand, the measurement system comprising:
for each measurand a measurement device determining and providing measured values of the respective measurand,
computing means connected to and/or communicating with each measurement device and configured to receive the measured values of each measurand,
a memory associated to the computing means, and
a computer program installed on the computing means which, when the program is executed by the computing means, cause the computing means to carry out the method of determining and providing the measurement result(s) for each measurand.

In certain embodiments of the measurement system:
the computing means are located in an edge device, in a superordinate unit or in the cloud, and
at least one or each measurement device is connected to and/or communicating with the computing means directly, via a superordinate unit, via an edge device located in the vicinity of the respective measurement device, and/or via the internet.

The present disclosure further includes a computer program comprising instructions which, when the program is executed by a computer, cause the computer to carry out the outlier detection method, or the method of determining and providing a measurement result for at least one measurand including the outlier detection method based on the measured values provided to the computer.

The present disclosure further includes a computer program product comprising this computer program and at least one computer readable medium, wherein at least the computer program is stored on the computer readable medium.

### BRIEF DESCRIPTION OF THE DRAWINGS

The present disclosure and further advantages are explained in more detail below based on the example shown in the figures of the drawing, wherein:

FIG. 1 shows method steps of an outlier detection method,

FIG. 2 shows method steps of a method of determining and providing a measurement result of a measurand,

FIG. 3 shows a measurement device performing the method shown in FIG. 2,

FIG. 4 shows a measurement system performing the method shown in FIG. 2,

FIG. 5 shows measured values of a measurand and filtered values of these measured values,

FIG. 6 shows a difference distribution of first differences of the filtered values shown in FIG. 5,

FIG. 7 shows a noise distribution determined based on residues between the measured values and the filtered values shown in FIG. 5,

FIG. 8 shows a combined distribution,

FIG. 9 shows a new measured value, filtered values and the combined distribution of FIG. 8, and

FIG. 10 shows method steps of a filtering method.

### DETAILED DESCRIPTION

The present disclosure concerns an outlier detection method, in particular a computer implemented outlier detection method, of detecting outliers in measured values my of a measurand m, as well as a method of determining and providing a measurement result MR of the measurand m using the outlier detection method.

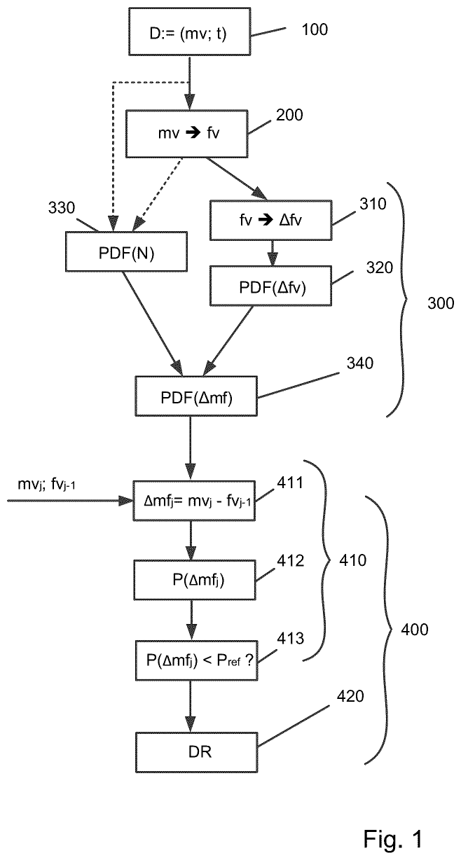

FIG. 1 shows a flow chart of the method steps of the outlier detection method. As shown in FIG. 1, the outlier detection method includes a method step 100 of continuously or repeatedly recording data D including measured values my of the measurand m and their time of determination t, a method step 200 of filtering the measured values my, a method step 300 of based on training data included in the recorded data D determining a combined distribution PDF(Δmf) representing a distribution of differences Δmf between individual measured values mvi and the filtered value fyi−1 of the preceding measured value mvi−1 preceding the respective individual measured value mvi to be expected in the specific application where the outlier detection method is applied, and a method step 400 of based on the combined distribution PDF(Δmf) identifying outliers included in new measured values mvj and of providing a corresponding detection result DR.

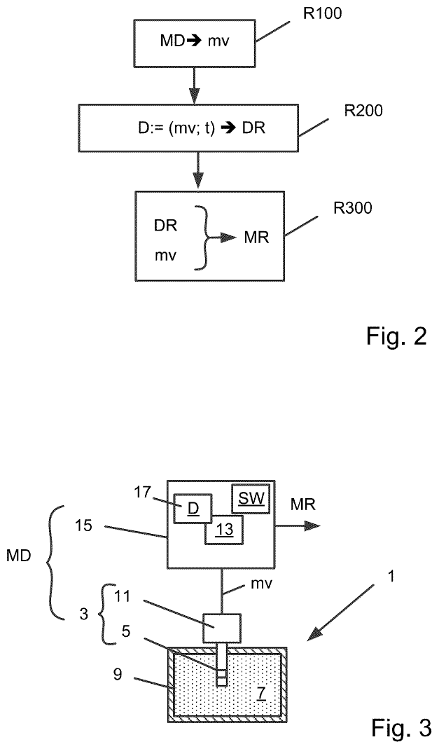

FIG. 2 shows a flow chart of the method steps of the method of determining and providing the measurement result MR of the measurand m. This method of using the outlier detection method includes a method step R100 of with a measurement device MD determining and providing the measured values my and their time of determination t, a method step R200 of performing the outlier detection method, and a method step R300 of determining and providing the measurement result MR based on the measured values my of the measurand m and the detection result DR determined by performing the outlier detection method.

The measurement device MD can be any device configured to determine the measurand m. In this respect, the measurement device MD is e.g. embodied in form of physical device installed at a measurement site repeatedly or continuously measuring the measurand m and determining and providing the corresponding measured values my. As an alternative, the measurement device MD may e.g. be embodied in form of a virtual or computer implemented device, e.g. in form of a soft sensor, repeatedly or continuously determining and providing measured values my of the measurand m based on data provided to the device.

The measurand m is e.g. a level, a pressure, a temperature, a density, a conductivity, a flow, a pH-value, a turbidity, or a spectral absorption of a medium, a concentration of an analyte comprised in a medium or another type of determinable variable. In certain embodiments, the measurand m is e.g. given by a variable of interest in a specific application, where the measurement device MD is employed, e.g. a process parameter related to a process performed at the measurement site and/or a property of a medium produced, processed and/or monitored at the measurement site. Examples of applications include industrial applications, e.g. production plants, chemical plants, water treatment or purification plants, as well as laboratory applications. Further examples include applications, wherein measurements are performed in a natural environment, as well as applications in medical diagnostics, e.g. applications wherein in-situ, in-vitro or in-vivo measurements are performed.

FIG. 3 shows an example, where the measurement device MD is installed at a measurement site 1. The measurement device MD shown includes a measurement unit 3 configured to determine, e.g. to measure, the measurand m and to provide the corresponding measured values my of the measurand m. In the example shown, the measurement unit 3 is or includes a sensor including a sensing element 5 exposed to a medium 7 contained in a container 9 and a measurement electronic 11 connected to the sensing element 5 determining and providing the measured values my based on a measurement signal provided by the sensing element 5. In the example shown, the sensor is e.g. an absorption sensor measuring a spectral absorption coefficient of the medium 7 or a concentration of an analyte comprised in the medium 7, a turbidity sensor measuring a turbidity of the medium 7, or a conductivity sensor measuring a conductivity of the medium 7.

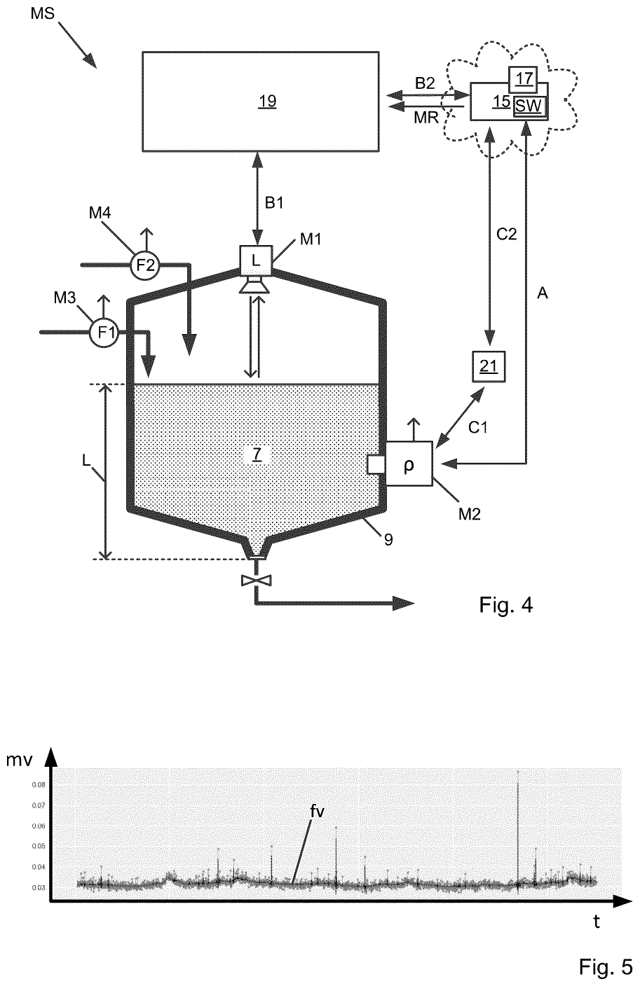

FIG. 4 shows an example of a measurement system MS including at least one measurement device measuring at least one measurand m of interest in the application, where the measurement system MS is employed. The exemplary measurement devices shown in FIG. 4 include a level measurement device M1 measuring a level L of a medium 7 contained in a container 9, a conductivity sensor M2 measuring a conductivity p of the medium 7 and two flow meters M3, M4 each measuring a flow F1, F2 of an additive flowing into the container 9. In applications, where two or more measurands m of interest are measured, the method of determining and providing the measurement result MR of the measurand m, is e.g. performed for at least one or each of the measurands m of interest at the specific application.

Even though the outlier detection method is described herein in context with the determination of measurement results MR, the field of use of the outlier detection method is not limited to this type of use. The outlier detection method can be employed in the same way in a multitude of other fields to detect outliers in time series of measured value my of a multitude of different types of measurands m. In this respect the term measurand m is used in a very broad sense to denominate a variable exhibiting variable values that are not completely random, and wherein at least some kind of dependency or relation between present and past variable values of the variable exists. This is e.g. the case when the variable values exhibit at least a certain level of (linear or non-linear) autoregression. As an example, signals exhibiting and/or representing a physical property evolving over time are, despite possible abrupt changes that may occur, are showing an autoregressive behavior. Regardless of the application, the outlier detection method is performed in the same way as described in more detail below based on the corresponding time series of measured values my and their time of determination t.

Regardless of the application and/or the field of use, the outlier detection is performed based on the combined distribution PDF(Δmf) representing the application-specific distribution of the differences Δmf between individual measured values mvi and the filtered value fyi−1 of the preceding measured value mvi−1 preceding the respective individual measured value mvi to be expected in the specific application where the outlier detection method is applied.

As mentioned above, the combined distribution PDF(Δmf) is determined based on training data included in the data D. The training data is e.g. unlabeled data and/or e.g. includes a predetermined number of measured values my and/or measured values my, that have been determined, e.g. measured, during an initial and/or a predetermined training time interval or during an arbitrarily selected time interval, e.g. a time interval of a predetermined duration.

To illustrate the outlier detection method, FIG. 5 shows a time series of recorded measured values my as a function of their time of determination t together with the corresponding filtered values fv indicated by a dotted line. The filtered values fv are e.g. determined and provided by means of a filter 13 filtering the measured values my in method step 200 shown in FIG. 1.

Determining the combined distribution PDF(Δmf) includes based on the filtered values fv of the measured values my included in the training data determining a difference distribution PDF(Δfv) of the first differences Δfv of the filtered values fv. As shown in FIG. 1, the difference distribution PDF(Δfv) is e.g. determined by performing a method step 310 of based on the filtered values fv determining the first differences Δfv of the filtered values fv. Starting with the filtered value fv of the second measured value my included in the training data, for each filtered value fv the first difference Δfvi is given by the difference Δfvi:=fvi−fvi−1 between the respective filtered value fvi and the filtered value fvi−1 preceding the respective filtered value fvi.

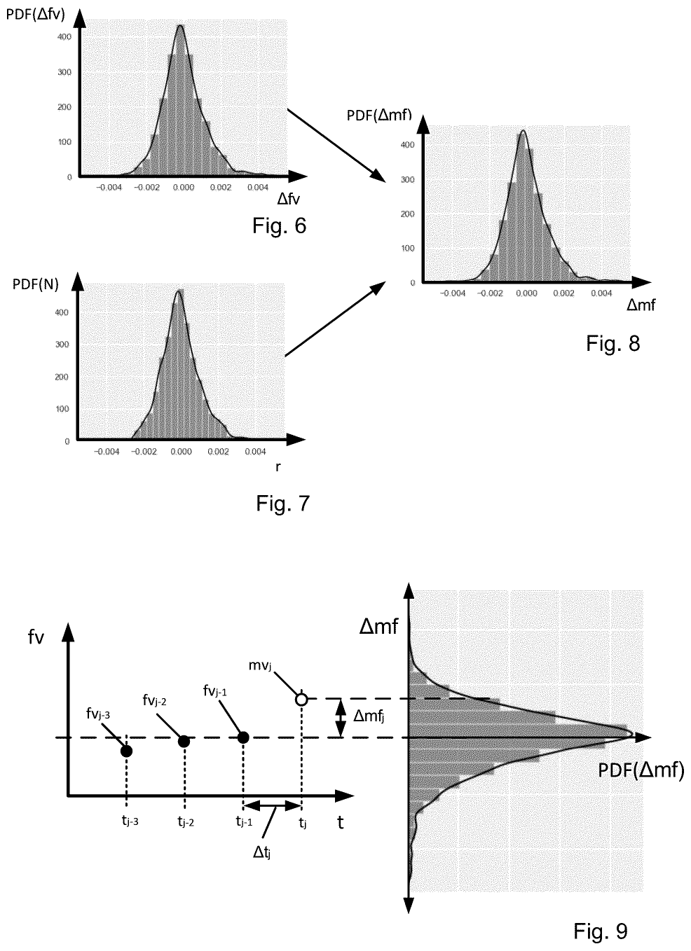

Next, in method step 320, the difference distribution PDF(Δfv) is determined based on the first differences Δfv. This is illustrated in FIG. 6 showing the difference distribution PDF(Δfv) determined based on the first differences Δfv of the filtered values fv shown in FIG. 5. Here, the difference distribution PDF(Δfv) is e.g. determined in form of a frequency distribution representing the frequencies of occurrence of first differences Δfv of different sizes as a function of their size, or in form of a probability density function representing the probability of occurrence of first differences Δfv as a function of their size. In the latter case, the probability density function is e.g. determined as or based on a distribution of the first differences Δfv determined based on the filtered values fv of the measured values my included in the training data.

Assuming, that the filtered values fv constitute a good approximation of the true value of the measurand m, the difference distribution PDF(Δfv) represents the distribution of the changes of the true value of the measurand m to be expected in the specific application, where the method is applied.

In applications, where the measured values my are determined at a constant rate, the time differences Δti:=ti−ti−1, between consecutively determined measured values mvi−1, mvi, and thus also between consecutive filtered values fvi−1, fvi are given by a constant time unit Δti:=Δt. In this case, the difference distribution PDF(Δfv) represents the distribution of first differences Δfv to be expected to occur in one time unit Δt. The method is not limited to applications, where the measured values my are determined at a constant rate. It can be performed in the same way in applications, where the time differences Δti:=ti−ti−1 between consecutively determined measured values mvi−1, mvi vary provided that the properties of the distribution of the time differences remains approximately constant throughout the performance of the method. In this case, the first differences Δfv of the filtered values fv determined in method step 310 include the first differences Δfv that occurred during each of the different time differences Δti between the measured values my included in the training data. Correspondingly, the resulting difference distribution PDF(Δfv) represents the distribution of first differences Δfv to be expected between consecutive filtered values fvi−1, fvi when the time differences Δti between the consecutively measured values mvi−1, mvi are compliant to the approximately constant distribution of time differences.

Method step 300 of determining the combined distribution PDF(Δmf) further includes a method step 330 of determining a noise distribution PDF(N) of noise included in the measured values my. In this respect different methods of determining the noise distribution PDF(N) can be employed.

As an example, available in applications, where the measured values my are determined and provided by a measurement device MD, the noise distribution PDF(N) is e.g. determined based on a measurement uncertainty inherent to the measurement device MD. The measurement uncertainty of measurement devices MD is usually specified by the manufacturer of the device and thus constitutes readily available information. Based on the measurement uncertainty, the noise distribution PDF(N) is e.g. determined in form of a gaussian distribution having a standard deviation corresponding to the size of the standard measurement uncertainty of the measurement device MD. This type of determination provides the advantage, that it requires very little calculating power and is very well suited for applications, where the measurement device MD is exposed to favorable measurement conditions.

As another example, the noise distribution PDF(N) is e.g. determined based on the measured values my included in the training data and the corresponding filtered values fv obtained by filtering the measured values my. In this case, determining the noise distribution PDF(N) is e.g. performed by determining residues r between the measured values my and the corresponding filtered values fv, e.g. as ri:=mvi−fvi, followed by determining the noise distribution PDF(N) shown in FIG. 7 as or based on the distribution of the residues r. Here, the noise distribution PDF(N) is e.g. determined in form of a frequency distribution representing the frequency of occurrence of residues r of different sizes as a function of their size, or in form of a probability density function representing the probability of occurrence of residues r as a function of their size. In the latter case, the probability density function is e.g. determined as or based on the frequency distribution of the residues r. This type of determination provides the advantage, that it truly reflects the properties of the noise present during the training time interval. Thus, it is very well suited for applications, where the properties of the noise are affected by application specific influences, e.g. by a process performed at the application and/or by application specific measurement conditions affecting the determination of the measured values my.

As another example, the noise distribution PDF(N) is e.g. determined in form of a combined noise distribution determined based on the distribution of the residues r and the measurement uncertainty inherent to the measurement device MD determining the measurand m. This provides the advantage, that a minimum noise caused by the measurement uncertainty is always accounted for. This is advantageous in applications where temporary noise reductions may occur, which may affect the training data. Accounting for a minimum noise due to the measurement uncertainty makes the outlier detection method more robust and reduces the number of false outlier detections, such as when the noise level rises following a temporary noise reduction.

In this embodiment, the noise distribution PDF(N) is e.g. determined based on the distribution of residues r between the measured values my included in the training data and the corresponding filtered values fv such, that the noise distribution PDF(N) represents a probability of occurrence of noise as a function of a noise amplitude, wherein for each noise amplitude covered by the noise distribution PDF(N) the probability of occurrence is larger or equal to a probability of occurrence of the respective noise amplitude due to the measurement uncertainty inherent to the measurement device MD.

Method step 300 of determining the combined distribution PDF(Δmf) further includes a method step 340 of based on the noise distribution PDF(N) and the difference distribution PDF(Δfv) determining the combined distribution PDF(Δmf) such, that it represents the distribution of differences Δmf between individual measured values mvi and the filtered value fvi−1 of the preceding measured value mvi−1 preceding the respective individual measured value mvi to be expected in the specific application due to the difference distribution PDF(Δfv) and the noise distribution PDF(N).

This is easily possible because by filtering of the measured values my performed in method step 200 a separation between the noise included measured values my and the filtered values fv constituting a good approximation of the true value of the measurand m is attained. Thus, each measured value my can be considered as the sum of the corresponding filtered value fv and a noise additive superimposed on the filtered value fv. Correspondingly, the difference between an individual measured value mvi and the filtered value fvi−1 of the preceding measured value mvi−1 can be interpreted as a sum of a first component and a second component. The first component corresponds to a first difference between two consecutive filtered values fv belonging to the difference distribution PDF(Δmf). The second component corresponds to a noise additive belonging to the noise distribution PDF(N). Thus, the combined distribution PDF(Δmf) is e.g. determined as or based on a convolution of the noise distribution PDF(N) and the difference distribution PDF(Δmf). Alternatively, the combined distribution is e.g. determined by Monte-Carlo simulations performed based on the noise distribution PDF(N) and the difference distribution PDF(Δmf).

This is illustrated in FIG. 8 showing the combined distribution PDF(Δmf) determined based on the difference distribution PDF(Δfv) shown in FIG. 6 and the noise distribution PDF(N) shown in FIG. 7. Just like the difference distribution PDF(Δfv) and the noise distribution PDF(N), the combined distribution PDF(Δmf) is e.g. determined in form of a frequency distribution representing the frequency of occurrence of differences Δmf of different sizes as a function of their size, or in form of a probability density function representing the probability of occurrence of the differences Δmf as a function of their size. In the latter case, the probability density function is e.g. determined as or based on a frequency distribution of differences Δmf.

Following the determination of the combined distribution PDF(Δmf) the method step 400 of identifying outliers included in the measured values my and of providing a corresponding outlier detection result DR is performed. As illustrated in FIG. 1, method step 400 includes a method step 410 of for at least one, several or each new measured value mvj, determining whether the respective new measured value mvj constitutes an outlier and a method step 420 of providing the detection result DR.

The new measured values mvj, are e.g. given by newly recorded measured values my, e.g. by new incoming measured values my and/or measured values my that have only just been provided by the same source as the training data.

As shown in method step 410, determining whether the respective new measured value mvj constitutes an outlier includes a method step 411 of determining the difference Δmfj:=mvj−fvj−1 between the respective new measured value mvj and the filtered value fvj−1 of the preceding

measured value mvj−1. Following this, it includes a method step 412 of determining a probability of occurrence P(Δmfj) of this difference Δmfj between the respective new measured value mvj and the filtered value fvj−1 of the preceding measured value mvj−1 according to the combined distribution PDF(Δmf).

This is illustrated in FIG. 9 showing an example of a new measured value mvj together with an extract of a time series of filtered values fv of previously determined measured values my including the filtered value fvj−1 of the preceding measured value mvj−1 that has been determined before the new measured value mvj on the left-hand side and the combined distribution PDF(Δmf) of the differences Δmf on the right-hand side.

In FIG. 9, the combined distribution PDF(Δmf) is shown in form of a probability density function illustrated in a graph having an ordinate representing the magnitude of the probability of occurrence of the differences Δmf and an abscissa representing the magnitude of the differences Δmf. The ordinate crosses the abscissa at a difference Δmv=0 of zero. The graph is positioned such, that an extension of the ordinate extends through the filtered value fvj−1 of the preceding measured

value mvj−1 shown on the left-hand side of FIG. 9.

The probability of occurrence P(Δmfj) of the difference Δmij between the respective new measured value mvj and the filtered value fvj−1 of the preceding measured value mvj−1 is e.g. determined as a probability of occurrence a difference Δmf of the size of the difference Δmfj between the respective new measured value mvj and the filtered value fvj−1 of the preceding measured value mvj−1 according to the combined distribution PDF(Δmf). As an example, the probability of occurrence P(Δmfj) is e.g. determined to be given by the minimum of a first probability P1 given by:

$$P 1 = {\int }_{- ∞}^{{mv}_{j} - f {v}_{j - 1}} C ( x ) d x$$

and a second probability P2 given by:

$$P 2 = 1 - {\int }_{- ∞}^{{mv}_{j} - {fv}_{j - 1}} C ( x ) d x$$

wherein C(x) is the combined distribution PDF(Δmf), wherein x is the difference between a measured value mvᵢ and the filtered value fvᵢ₋₁ of the preceding measured value mvᵢ₋₁, and wherein the probability of occurrence P(Δmfj) is given by P(Δmfj):=min([P1, P2]).

Following this, in method step 413 the probability of occurrence P(Δmfj) the difference Δmfj determined for the respective new measured value mvj is compared to a predetermined level of confidence Pref and the respective new measured value mvj is identified as an outlier when the probability of occurrence P(Ain) is lower than the predetermined level of confidence Pref.

Based on the at least once, repeatedly or continuously performed outlier identification, the corresponding detection result DR is preferably determined and provided in a form that best suits the needs of the application, where the method is employed. To this extent providing the detection result DR e.g. includes indicating each new measured value mvj that has been identified as an outlier. This is advantageous in applications, wherein regulation and/or control of the measurand m, a process performed at the application and/or operation of a facility is performed in real time on the basis of the latest measured value(s) my, as well as in applications wherein decisions are made and/or actions are taken in real time based on the most recent measured value(s) my of the measurand.

In addition, or as an alternative providing the detection result DR e.g. includes issuing a wanting when an outlier has been identified and/or issuing a notification or an alarm when a predetermined number of consecutively determined new measured values mvj has been identified as outliers. This is advantageous in applications, wherein events may occur, that lead to an unexpectedly large and/or rather sudden change of the measurand m and/or the measured values my. Examples include events given by impairments of a process performed at the application, an impaired operation of a facility, as well as impairments of the measurement device MD determining the measured values my. In this case, the occurrence of the predetermined number of consecutively determined new measured values mvj that have been identified as outliers is an indicator that such an event has occurred, and this information is provided in form of the alarm or the corresponding notification. Thus, the corresponding notification or alarm enables to differentiate between individual outliers, that may e.g. be safely ignored or discarded, and the occurrence of a real event, that may require attention and/or actions to be taken. The information enabling or providing this differentiation is e.g. provided to a user by providing the corresponding detection result DR. In this context the user of the detection result DR is e.g. a person or a machine, e.g. a superordinate unit, a process automation system, or a programmable logical controller receiving the detection result DR.

When the outlier detection method is used in the method of determining and providing the measurement result MR of the measurand m shown in FIG. 2, in method step R300 the measurement result MR is determined based on the measured values my and the detection result DR. Just like the detection result DR, the measurement result MR is preferably determined and provided in a form that best suits the needs of the application, where the method is employed.

As an example, determining and providing the measurement result MR e.g. includes providing the detection result DR and providing the measured values my, the filtered values fv of the measured values my, and/or processed measured values pmv determined based on the measured values my and/or the filtered values fv.

As another example, in certain embodiments, determining and providing the measurement result MR e.g. includes based on the detection result DR eliminating each outlier that has been identified and determining and providing the measurement result MR as or based on the remaining measured values mv′ remaining after the outliers have been eliminated. In this case, providing the measurement result MR e.g. includes providing the remaining measured values mv′, providing filtered values fv′ of the remaining measured values mv′, and/or providing processed measured values pmv′ determined based on the remaining measured values mv′ and/or filtered values fv′ of the remaining measured values mv′. As an option, in this embodiment, providing the measurement result MR may additionally include providing the detection result DR, e.g. by indicating each new measured value mvj that has been identified as an outlier, by issuing a warning when an outlier has been identified and/or by issuing a notification or an alarm when a predetermined number of consecutively determined new measured values mvj has been identified as outliers.

The present disclosure provides the advantages mentioned above. Individual steps of the outlier detection method and/or the method of determining the measurement result MR can be implemented in different ways without deviating from the scope of the present disclosure. Several optional embodiments are described in more detail below.

As an example, in certain embodiments, the outlier detection method may include an additional method step of at least once, repeatedly, or periodically updating the combined distribution PDF(Δmf). In this case each update is e.g. performed by repeating the method step 300 of determining the combined distribution PDF(Δmf) based on new training data included in the recorded data D. In this case, the new training data includes at least one measured value my, that has been determined after a training time interval during which the measured values my included in the training data employed to determine the previous combined distribution PDF(Δmf) have been determined.

Following each update of the combined distribution PDF(Δmf), the method step 400 of determining and providing the detection result DR is then performed as described above based on the updated combined distribution PDF(Δmf). Thus, following each update, each determination of the probability of occurrence P(Δmfj) of the difference Δmfj between the respective new measured value mvj and the filtered value fvj−1 of the preceding measured value mvj−1 preceding the respective new measured value mvj is subsequently performed based on the updated combined distribution PDF(Δmf).

Updating of the combined distribution PDF(Δmf) is advantages in applications, where properties of the measured values my and/or properties of the noise included in the measured values my may change over time. In this case, each update provides the advantage, that changes of these properties that may have occurred since the last determination of the combined distribution PDF(Δmf) are accounted for.

With respect to the respective new training data, the number of updates and/or the frequency of the updates of the combined distribution PDF(Δmf) various strategies can be pursued individually and/or in combination.

In certain embodiments, updating the combined distribution PDF(Δmf) is e.g. performed at least once, repeatedly, or periodically based on new training data including a given number larger or equal to one of measured values my that have been determined after the training time interval during which the measured values my included in the training data employed to determine the previously determined combined distribution PDF(Δmf) have been determined. Correspondingly frequent updates are advantages in applications, where the properties of the measured values my and/or the noise may change quickly.

In addition, or as an alternative, the combined distribution PDF(Δmf) is e.g. updated at least once, repeatedly, or periodically based on new training data including measured values my, that have been determined during a time interval of a predetermined duration preceding the determination of the respective updated combined distribution PDF(Δmf).

In addition, or as an alternative, the combined distribution PDF(Δmf) is e.g. updated after an event that may have an impact on the properties of the measured values my and/or the properties of the noise included in the measured values my has occurred. In context with the method of determining the measurement result MR events triggering an update of the combined distribution PDF(Δmf) to be determined e.g. include: a maintenance performed at the measurement site and/or on the measurement device MD, a repair, a modification or a replacement of the measurement device MD, a shutdown of the measurement site and/or an interruption of a process performed at the measurement site, and/or a change of the process application and/or a process performed at the application, where the measurement device MD is employed.

In addition, or as an alternative the combined distribution PDF(Δmf) is e.g. updated after an event given by a change of the constant time interval Δt between consecutively determined measured values mvi, mvi−1 or a change of at least one of the properties of the distribution of the time differences Δti between consecutively determined measured values mvi, mvi−1.

In certain embodiments, the combined distribution PDF(Δmf) is e.g. updated after an event given by a time difference between a new measured value mvj and the preceding measured

value mvj−1 exceeding a predetermined time limit. Such a situation may e.g. occur, when the measurement of the measurand m and/or a process performed at the measurement site is interrupted and/or when transmission and/or reception of the measured values my to be recorded is temporarily interrupted.

Regardless of the type of event triggering the update, the updated combined distribution PDF(Δmf) is e.g. determined based on new training data including at least a predetermined number of measured values my that have been determined after the event, and/or measured values my that have been determined during a time interval having a duration longer or equal to a minimum duration after the event occurred.

In addition, or as an alternative, updating the combined distribution PDF(Δmf) e.g. includes a method step of determining a degree of similarity between the new training data and the training data employed for the previous determination of the distribution PDF(Δmf). In this case, the combined distribution PDF(Δmf) is preferably only updated when the degree of similarity is below a predetermined threshold. In addition, or as an alternative, updating the combined distribution PDF(Δmf) is preferably postponed in case the degree of similarity exceeds the predetermined threshold. When the updating is postponed, it is e.g. postponed to a later time when sufficiently dissimilar new training data becomes available.

With respect to the filtering of the measured values my performed in method step 200 filters 13 performing filtering methods known in the art can be employed. Excellent filtering results are e.g. attained by the filtering method disclosed in German Patent Application DE 102022111387.6 filed on May 6, 2022, incorporated herein by reference.

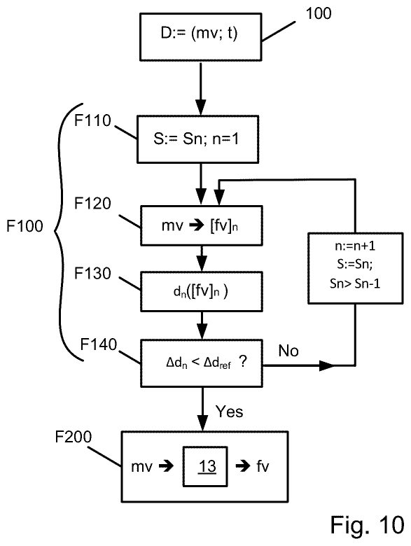

When this filtering method is employed in the outlier detection method disclosed herein, the filtering method is performed based on the data D recorded in method step 100. As illustrated in the flow chart shown in FIG. 10 this filtering method includes a method step F100 of based on training data included in the recorded data D parametrizing a filter 13 having an adjustable filtering strength S. To this extent parametrizable filters known in the art can be used. As an example, the filter 13 is e.g. a smoothing filter, a sliding window filter, e.g. a moving average filter, a Savitzky-Golay filter or a wavelet decomposition filter. As an alternative, the filter 13 is e.g. an autoregressive filter (AR-filter), a moving average filter (MA-filter), an autoregressive moving average filter (ARMA-filter), an autoregressive integrated moving average filter (ARIMA-filter) or a seasonal autoregressive moving average filter (SARIMA-filter). As an example, the filter 13 is e.g. an ARIMA filter configured, e.g. programmed, to determine filtered values of the measured values my based on an autoregressive integrated moving average model (ARIMA model) that is fitted to the time series of the measured values my. As an alternative the filter 13 is e.g. a network filter or a neural network filter. As an example, a neural network filter including a neural network or a convolutional neural network for determining the filtered values is e.g. employed. In this case, a neural network configured to process a data sequence, e.g. a recurrent neural network, such as a Long short-term memory (LSTM), is preferably employed.

Regardless of the type of filter employed, the filter 13 is e.g. configured to operate based on parameter settings, that are adjustable in a manner that enables for the filtering strength S of the filter 13 to be set to a number of different predetermined filtering strength Sn. In certain embodiments, the filtering strength S is e.g. understood as a conceptual indication reflecting how much noise included in the measured values my will be taken out by the filter 13 being adjusted to have the respective filtering strength S.

As shown in FIG. 10, parametrizing the filter 13 starts with a method step F110 of setting the filtering strength S of the filter 13 to a predetermined initial filtering strength 51, given by S:=Sn; n=1, followed by a process of performing a method step F120 of with the filter 13 filtering the time series of measured values my included in the training data and a method step F130 of determining a fractal dimension d1 of the filtered values [fy]1 provided by the filter 13. This process is iteratively repeated by setting n:=n+1 and by increasing the filtering strength S of the filter 13 to a higher filtering strength S:=Sn; Sn>Sn−1, followed by performing the method step F120 of filtering the time series of measured values my included in the training data and the method step F130 of determining the fractal dimension dn of the thus determined filtered values [fv]n until a decay of the fractal dimensions Δdn determined at the end of each iteration n drops below a predetermined threshold Δdref.

As illustrated in FIG. 10, this is e.g. attained by the filtering method including a method step F140 of at the end of each iteration n determining the decay of the fractal dimensions Δdn and determining whether the decay of the fractal dimensions Δdn is above or below the predetermined threshold Δdref. In case the decay of the fractal dimensions Δdn is above the threshold Δdref the next iteration n:=n+1 is performed by increasing the filtering strength S, filtering the time series of measured values my and determining the fractal dimension dn of the filtered values [fv]n, which is again followed by method step F140 of determining whether the decay of the fractal dimensions Mn has dropped below the predetermined threshold Δdref. This iterative process is repeated until the decay of the fractal dimensions Mn drops below the threshold Δdref.

In context of the filtering method, various methods of determining the decay of the fractal dimensions Δdn can be employed. As a first example, the decay of the fractal dimensions Δdn is e.g. determined for each iteration n individually based on the fractal dimension d0 of the measured values my included in training data. In this case each iteration n e.g. includes a step of determining the decay of the fractal dimensions Δdn as or based on a ratio of the fractal dimension dn determined during the respective iteration n and the fractal dimension d0 of the unfiltered measured values my included in training data, e.g. by Δdn:=dn/d0. As a second example, for each iteration n, the decay of the fractal dimensions Mn is e.g. determined based on the fractal dimension dn determined during the respective iteration n and the fractal dimension dn−1 determined during the previous iteration n−1. In this case each iteration n e.g. includes a step of determining the decay of the fractal dimensions Δdn as or based on a ratio of the fractal dimension dn determined during the respective iteration n and the fractal dimension dn−1 determined during the previous iteration n−1,

e.g. by Δdn:=dn/dn−1. As an alternative another method of determining the decay of the fractal dimensions Δdn at the end of each iteration n can be employed instead. Examples include a method of determining the decay of the fractal dimensions Δdn based on three or more of the previously determined fractal dimensions di, dj, dk, . . . ; i, j, k . . . ∈[0, 1, . . . , n]; i≠j≠k and/or based on a property of a function fitted to several or all of the previously determined fractal

dimensions d0, d1, . . . , dn.

Regardless of the method applied to determine the decays of the fractal dimensions Δdn the iterative process is terminated when the decay of the fractal dimensions Mn drops below the predetermined threshold Δdref. Following this, in method step F200 of the filtering method, the filter 13 is put into operation based on the parametrization corresponding the filtering strength Sn applied in the last iteration n. Subsequently, the measured values my are filtered and the corresponding filtered values fv are determined and provided by the thus parametrized filter 13.

The fractal dimensions dn of the filtered values [fv]n provide a quantitative measure of the complexity of the filtered values [fv]n. Correspondingly, the sequence of fractal dimensions dn determined during the iterations n provide a quantitative measure of the parameter-dependent capability of the filter 13 to eliminate the noise included in the measured values my. Thus, the parametrization determined based on the decays of the fractal dimensions Mn constitutes an optimum parametrization most capable of separating the main component of the measured values my representing the true value of the measurand m from the noise in view of the application specific properties of the measured values my and the application specific properties of the noise. Another advantage is, that this optimum parametrization is determined in an entirely data driven manner, that neither requires an expert analysis nor any prior knowledge of the properties of the measured values my and the noise.

Using this filtering method in the outlier detection method provides the advantage, that a very high degree of accuracy and reliability of the combined distribution PDF(Δmf) is attained. This is so, because the high degree of trueness of the filtered values fv to the true values of the measurand m ensures a correspondingly high degree of accuracy and reliability of the difference distribution PDF(Δfv) as well as of the noise distribution PDF(N) determined based on the residues r between the measured values my and the filtered values fv.

In certain embodiments, the outlier detection method may include an additional method step of at least once, periodically, or repeatedly updating the parametrization of the filter 13. In this case each update is e.g. performed by repeating the method step F100 of parametrizing the filter 13 based on new training data included in the recorded data D, that includes at least one measured value my that has been determined and/or recorded after the parametrization of the filter 13 has last been determined. Following each update of the parametrization, the filtered values fv of the measured values my are then determined with the filter 13 operating based on the updated parametrization. As an example, the parametrization of the filter 13 is e.g. updated each time the combined distribution PDF(Δmf) is updated. In this case, the new training data employed to determine the updated combined distribution PDF(Δmf) is e.g. also applied to determine the updated parametrization.

The outlier detection method and/or the method of determining the measurement result MR disclosed herein is preferably performed as a computer implemented method. In that case, the method steps of the respective method, in particular the method step 300 of determining the combined distribution PDF(Δmf) and the method step 400 of determining and providing the detection result DR based on the combined distribution PDF(Δmf) are performed by computing means 15 by means of a computer program SW based on the measured values my and their time of determination t provided to the computing means 15. Thus, the present disclosure is also realized in form of a computer program SW comprising instructions which, when the program is executed by a computer, cause the computer to carry out the respective method disclosed herein. In addition, the present disclosure further comprises a tangible computer program product comprising the computer program SW described above and at least one computer readable medium, wherein at least the computer program SW is stored on the computer readable medium.

In computer implemented embodiments, the filter 13 and/or the filtering method performed in method step 200 disclosed herein are e.g. implemented in software included in the computer program SW.

When the respective method is performed as a computer implemented method, the data D is e.g. transferred to and at least temporarily stored in a memory 17 associated to the computing means 15. The computing means 15 is e.g. embodied as a unit including hardware, e.g. one or more computing units or processors, a computer, or a computing system.

The present disclosure disclosed herein is also realized in form of the measurement device MD configured to perform the method of determining and providing the measurement result MR disclosed herein. In the example shown in FIG. 3, the measurement device MD includes the measurement unit 3 measuring the measurand m and providing the measured values my, the computing means 15, the memory 17 and the computer program SW installed on the computing means 15 which, when the program is executed by the computing means 15, cause the computing means 15 to carry out the method of determining and providing the measurement result MR as described above based on the measured values my provided to the computing means 15 by the measurement unit 3.

As an alternative option, the computing means 15 and the memory 17 may be located outside the measurement device MD. Thus, regardless of the location of the computing means 15 and the memory, the present disclosure disclosed herein is also realized in form of a measurement system MS comprising the measurement device MD determining and providing the measured values my, the computing means 15 configured to receive the measured values my and to provide the measurement results MR determined by the computing means 15, the memory 17 associated to the computing means and the computer program SW installed on the computing means 15 which, when the program is executed by the computing means 15, cause the computing means 15 to carry out the method of determining and providing the measurement result MR as described above based on the measured values my provided to the computing means 15 by the measurement device MD.

When the computing means 15 are located outside the measurement device MD, the measured values my determined by the measurement device MD are directly or indirectly provided to the computing means 15 or the memory 17 associated to the computing means 15. To this extent hard wired or wireless connections and/or communication protocols known in the art, like e.g. LAN, W-LAN, Fieldbus, Profibus, Hart, Bluetooth, Near Field Communication, TCP/IP etc. can be applied.

In certain embodiments, the measurement system MS, may include more than one measurement device MD. In this case, the computing means 15 are configured to receive the measured values my provided by each of the measurement devices MD and to provide the corresponding measurement results MR determined by the computing means 15 by executing the computer program SW for each of the measurands m determined or measured by the respective measurement device MD.

In the example shown in FIG. 4, the measurement system MS is configured to perform the method of determining and providing the measurement results MR for at least one or each of the measurands L, ρ, F1, F2 measured by the measurement devices M1, M2, M3, M4 and the computing means 15 and the memory 17 are embodied in the cloud. Thus, in this example, cloud computing is applied. Cloud computing denominates an approach, wherein IT—infrastructure, like hardware, computing power, memory, network capacity and/or software are provided via a network, e.g. via the internet.

In FIG. 4, each measurement device M1, M2, M3, M4 is e.g. connected to and/or communicating with the computing means 15 directly as illustrated by the arrow A shown in FIG. 4, via a superordinate unit 19, e.g. a programmable logical controller, as illustrated by the arrows B1 and B2, and/or via an edge device 21 located in the vicinity of the measurement devices M1, M2, M3, M4 as indicated by the arrows C1, C2. As an example, at least one or each of the measurement devices M1, M2, M3, M4, the edge device 21 and/or the superordinate unit 19 may be directly or indirectly connected to the computing means 15 via the internet, e.g. via a communication network, like e.g. TCP/IP. As an alternative option, the computing means 15 and the memory 17 included in the measurement system MS may e.g. be located in the vicinity of the measurement device(s) MD, M1, M2, M3, M4, e.g. in the edge device 21 or in the superordinate unit 19 shown in FIG. 4.

Regardless of the number of measurands m, L, ρ, F1, F2 for which the method disclosed herein is performed and regardless of the location of the computing means 15 employed to determine the corresponding measurement result(s) MR, the measurement result(s) MR determined by the method disclosed herein provide the advantage, that outliers included in the measured values my are identified. This enables for the risk of wrong decisions to may be made, and/or unsuitable actions to be performed based on outliers to be eliminated. Correspondingly, the measurement result(s) MR provided by the method can be safely employed and/or are employed to monitor, to regulate and/or to control the respective measurand m, L, ρ, F1, F2, an operation of a plant or facility, e.g. a production facility, and/or at least one step of a process, e.g. a production process, performed at the application, where the measurement device(s) MD, M1, M2, M3, M4, is/are employed. In the example shown in FIG. 4, the measurement result(s) MR of the measurand(s) L, ρ, F1 and/or F2 are provided to the superordinate unit 19 configured to monitor, to regulate and/or to control the respective measurand L, ρ, F1, F2, an operation of a plant or facility, and/or at least one step of a process performed at the application, where the measurement device(s) M1, M2, M3, M4 are installed.

1. A non-transitory computer readable medium storing instructions that, when executed by a computer, cause it to perform the following computer implemented outlier detection method comprising the steps of:
continuously or repeatedly recording data including measured values of the measurand and their time of determination,
determining filtered values of the measured values by filtering the measured values,
based on training data included in the recorded data determining a combined distribution of differences between individual measured values and the filtered value of the measured value preceding the respective individual measured value to be expected in the specific application where the outlier detection method is applied by performing the steps of:
based on the filtered values of the measured values included in the training data determining a difference distribution of first differences of the filtered values,
determining a noise distribution of noise included in the measured values, and
based on the noise distribution and the difference distribution determining the combined distribution,
identifying outliers by for at least one, several or each new measured value performing the steps of:
determining a difference between the respective new measured value and the filtered value of the measured value preceding the respective new measured value,
determining a probability of occurrence of this difference between the respective new measured value and the filtered value of the preceding measured value according to the combined distribution, and
identifying the respective new measured value as an outlier when the probability of occurrence of this difference is lower than a predetermined level of confidence, and
providing a detection result by performing at least one of: indicating each new measured value that has been identified as an outlier, issuing a warning when an outlier has been identified, and issuing a notification or an alarm when a predetermined number of consecutively determined new measured values has been identified as outliers.

2. The non-transitory computer readable medium of claim 1, wherein the noise distribution is determined:
as or based on a distribution of residues between the measured values included in the training data and the corresponding filtered values, or
based on a measurement uncertainty inherent to a measurement device determining and providing the measured values of the measurand, or
in form of a combined noise distribution determined based on the distribution of residues between the measured values included in the training data and the corresponding filtered values and a measurement uncertainty inherent to a measurement device determining and providing the measured values of the measurand, or
based on a distribution of residues between the measured values included in the training data and the corresponding filtered values such, that the noise distribution represents a probability of occurrence of noise as a function of a noise amplitude, wherein for each noise amplitude covered by the noise distribution the probability of occurrence is larger or equal to a probability of occurrence of noise of having the respective noise amplitude due to a measurement uncertainty inherent to a measurement device determining and providing the measured values of the measurand.

3. The non-transitory computer readable medium of claim 1, further including the steps of:
updating the combined distribution based on new training data included in the recorded data, and
subsequently performing the identification of outliers based on the updated combined distribution,
wherein updating of the combined distribution:
a) is performed at least once, repeatedly, or periodically,
b) is performed at least once, repeatedly, or periodically based on new training data including a given number larger or equal to one of measured values that have been determined after a training time interval during which the measured values included in the training data employed to determine the previously determined combined distribution have been determined,
c) is performed at least once, repeatedly, or periodically based on new training data including measured values, that have been determined during a time interval of a predetermined duration preceding the determination of the respective updated combined distribution,
d) is performed after an event occurred, that may have an impact on properties of the measured values and/or on properties of the noise,
e) is performed after an event given by a change of a constant time interval between consecutively determined measured values or by a change of at least one property of a distribution of time differences between consecutively determined measured values,
f) is performed after an event given by a time difference between a new measured value and the preceding measured value exceeding a predetermined time limit, and/or
g) includes a method step of determining a degree of similarity between the new training data and the training data employed in the previous determination of the combined distribution, followed by a method step of: updating the combined distribution when the degree of similarity is below a predetermined threshold and/or postponing the updating of the combined distribution in case the degree of similarity exceeds the predetermined threshold.

4. The non-transitory computer readable medium of claim 1, wherein the method step of filtering the measured values comprises:
based on the training data included in the data determining a parametrization for a filter having an adjustable filtering strength by:
setting the filtering strength to a predetermined initial filtering strength,
performing a process of by means of the filter filtering the measured values included in the training data and determining a fractal dimension of the filtered values provided by the filter, and
iteratively repeating this process by increasing the filtering strength of the filter to a higher filtering strength and by subsequently filtering the measured values and determining the fractal dimension of the filtered values determined by the filter having the higher filtering strength until a decay of the fractal dimensions determined at the end of each iteration of the process drops below a predetermined threshold, and
performing the filtering of the measured values with the filter operating based on a parametrization corresponding to the filtering strength employed in the last iteration.

5. The non-transitory computer readable medium of claim 4, wherein each iteration includes a method step of determining the decay of the fractal dimensions:
a) as or based on a ratio of the fractal dimension of the filtered values determined during the respective iteration and a fractal dimension of the unfiltered measured values included in training data, or
b) as or based on a ratio of the fractal dimension of the filtered values determined during the respective iteration and the fractal dimension of the filtered values determined during the previous iteration, or
c) based on three or more of the previously determined fractal dimensions and/or based on a property of a function fitted to several or all previously determined fractal dimensions.

6. The non-transitory computer readable medium of claim 4, wherein the parametrization of the filter is updated when the combined distribution is updated.

7. The non-transitory computer readable medium of claim 1, wherein:
the identification of outliers is performed in real time, and/or
the training data is unlabeled data and/or includes a predetermined number of measured values and/or measured values that have been measured during an initial and/or a predetermined training time interval or an arbitrarily selected time interval of a predetermined duration.

8. A method of using the non-transitory computer readable medium of claim 1, in a method of determining and providing a measurement result of a measurand comprising the steps of:
by means of a measurement device repeatedly or continuously determining and providing measured values of the measurand,
wherein the measurement device is either:
a physical device measuring the measurand at a measurement site, or
is given by a virtual device, a computer implemented device or a soft sensor repeatedly or continuously determining and providing the measured values of the measurand based on data provided to it,
based on the measured values and their time of determination performing the outlier detection method, and
determining and providing the measurement result of the measurand based on the measured values and the detection result determined by performing the outlier detection method.

9. The method of claim 8, wherein:
a) providing the measurement result includes providing the detection result and providing the measured values, filtered values of the measured values, and/or processed measured values determined based on the measured values and/or the filtered values, or
b) determining the measurement result includes based on the detection result eliminating each new measured value that has been identified as an outlier and determining and providing the measurement result includes at least one of:
b1) providing the remaining measured values remaining after the outliers have been eliminated,
b2) providing filtered values of the remaining measured values,
b3) providing processed measured values determined based on the remaining measured values and/or based on filtered values of the remaining measured values, and
b4) performing at least one of: providing the detection result, indicating each new measured value that has been identified as an outlier, issuing a warning when an outlier has been identified and/or issuing a notification or an alarm when a predetermined number of consecutively determined new measured values has been identified as outliers.

10. The method of claim 8, further including at least one of the steps of:
monitoring, regulating and/or controlling the measurand or at least one of the measurands, monitoring, regulating and/or controlling an operation of a plant or facility and/or monitoring, regulating and/or controlling at least one step of a process performed at an application, where the measurement device(s) is/are employed, based on the measurement result(s), and
providing the measurement result(s) of the measurand(s) to a superordinate unit configured to monitor, to regulate and/or to control the respective measurand, an operation of a plant or facility, and/or at least one step of a process performed at the application, where the measurement device(s) determining the measured values of the measurand(s) is/are employed.

11. A measurement device configured to perform the method according to claim 8, comprising:
a measurement unit configured to determine and to provide the measured values of the measurand,
computing means, a memory associated to the computing means and a computer program installed on the computing means which, when the program is executed by the computing means, cause the computing means to carry out the method of determining and providing the measurement result based on the measured values provided to the computing means by the measurement unit.

12. A measurement system configured to perform the method of claim 8 for at least one measurand, the measurement system comprising:
for each measurand a measurement device determining and providing measured values of the respective measurand,
computing means connected to and/or communicating with each measurement device and configured to receive the measured values of each measurand,
a memory associated to the computing means, and
a computer program installed on the computing means which, when the program is executed by the computing means, cause the computing means to carry out the method of determining and providing the measurement result(s) for each measurand.

13. The measurement system of claim 12, wherein:
the computing means are located in an edge device, in a superordinate unit or in the cloud, and
at least one or each measurement device is connected to and/or communicating with the computing means directly, via a superordinate unit, via an edge device located in the vicinity of the respective measurement device, and/or via the internet.
